(19) United States
(12) Patent Application Publication
(10) Pub. No.: US 2014/0203099 A1
(43) Pub. Date: Jul. 24, 2014

(54) ULTRASONIC PRODUCED WATER DISPERSION DEVICE, SYSTEM AND METHOD

(71) Applicant: Cenovus Energy Inc., Calgary (CA)

(72) Inventors: Cindy Wolfe, Calgary (CA); Ken Lowe, Calgary (CA)

(73) Assignee: Cenovus Energy Inc., Calgary (CA)

(21) Appl. No.: 14/161,606

(22) Filed: Jan. 22, 2014

Related U.S. Application Data
(60) Provisional application No. 61/755,253, filed on Jan. 22, 2013.

(51) Int. Cl. B05B 17/06

(52) U.S. Cl. CPC B05B 17/0615
USPC 239/4; 239/102.2

(57) ABSTRACT

An ultrasonic dispersion system for dispersing fluid collected from a wellbore during hydrocarbon production is disclosed. The system comprises a holding tank for containing a fluid collection; a fluid intake in communication with the holding tank for input of fluid collected from a wellbore; and an air intake in communication with the holding tank. An ultrasonic generator bank positioned in the holding tank for contact with the fluid collection is used for particlizing the fluid collection to generate an air/particle mixture with the air input into the holding tank. The ultrasonic generator bank comprises an ultrasonic source positioned below the surface of the fluid collection for particlizing at least a portion of the fluid collection; a power source for providing power to the ultrasonic generator bank; and an outlet in an upper region of the holding tank for exhausting the air/particle mixture from the holding tank.

### CROSS-REFERENCE TO RELATED APPLICATIONS

This application claims priority to U.S. Provisional Application Ser. No. 61/755,253, filed Jan. 22, 2013, the disclosure of which is incorporated herein by reference in its entirety.

### BACKGROUND OF THE INVENTION

1. Field of the Invention

The invention relates to systems, devices and methods for disposing of water produced at hydrocarbon production wells and more specifically to ultrasonic particlizing systems, devices and methods for dispersing water produced at hydrocarbon production wells.

2. Description of the Related Art

Wells producing hydrocarbon liquids or gases commonly also produce water (what is referred to in the industry as “produced water”). The produced water, and any entrained solids or trace hydrocarbons, are treated and disposed of in a regulated manner. Generally, commercially viable amounts of oil and condensates are removed from the produced water before disposal.

Surface disposal of the produced water by the hydrocarbon well is generally not allowed.

Commonly, produced water is disposed of by injection into a regulated “disposal reservoir zone”, although disposal zones are not always available. Injection disposal is energy intensive and expensive. In addition, injection introduces the risk of creating seismic shock. Further, injection disposal of the produced water removes potentially useful water from the environment. Vaporizing and dispersing produced water in the air as gas phase water vapour is generally permitted but would be more energy intensive than injection.

A need therefore exists for a system, method and/or device for water disposal at a hydrocarbon producing well or facility that overcomes at least one of the above mentioned shortcomings associated with existing technologies or at least overcomes at least one shortcoming inherent to existing and potential systems, methods and/or devices further to those shortcomings described above.

### SUMMARY OF THE INVENTION

This invention offers an alternative dispersion method to traditional injection and vaporization (phase change from liquid to gas) methods employed. This dispersion method which creates ultra fine particles of liquid, typically water, using ultrasonics which are dispersed in the atmosphere, or into a secondary treatment system if particulate or dissolved substances would require removal prior to dispersion, and behave in a gas-like manner for dispersion at a well site or facility following collection from the hydrocarbon producing well. Although the particlized liquid behaves in a gas-like manner for dispersion, particlization generally requires less energy than vaporization and places the liquid, the majority of which is typically water, back into the eco-system.

Fluid collected from a wellbore is deposited into a holding tank. A gas, such as air, is input into the holding tank. A particle generator placed in the holding tank and in contact with the deposited fluid is used to particlize the fluid to generate an air/particle mixture which is then exhausted from the holding tank and dispersed into the atmosphere, or into a secondary treatment system for example for removal of particulate or dissolved substances prior to dispersion for re-introduction into the eco-system. An energy input system sufficient to cause the ultrasonic droplets to change phase from liquid to vapour either before or after entering the secondary treatment system may also be included.

In one embodiment, the present invention provides for an ultrasonic dispersion system for dispersing fluid collected from a wellbore during hydrocarbon production, the ultrasonic dispersion system comprising:

a holding tank for containing a fluid collection;

a fluid intake in communication with the holding tank for input of fluid collected from a wellbore;

an air intake in communication with the holding tank for input of air;

an ultrasonic generator bank in the holding tank for contact with the fluid collection for particlizing the fluid collection to generate an air/particle mixture with the air input into the holding tank; the ultrasonic generator bank comprising:
an ultrasonic source for positioning below the surface of the fluid collection for particlizing at least a portion of the fluid collection;

a power source for providing power to the ultrasonic generator bank; and

an outlet in an upper region of the holding tank for exhausting the air/particle mixture from the holding tank into the atmosphere or into a secondary treatment system prior to dispersion.

In another embodiment of the ultrasonic dispersion system or systems outlined above, the ultrasonic particle generator bank further comprises a buoyancy control for positioning the ultrasonic source a desired depth below the surface of the fluid collection.

In another embodiment of the ultrasonic dispersion system or systems outlined above, the desired depth is between about 0 mm and 4 mm.

In another embodiment of the ultrasonic dispersion system or systems outlined above, the desired depth is about 1.0 mm or less.

In another embodiment of the ultrasonic dispersion system or systems outlined above, the system or systems further comprise:

an electrical conveyance electrically connecting the power source and the ultrasonic particle generator bank.

In another embodiment of the ultrasonic dispersion system or systems outlined above, the electrical conveyance further comprises a length management system for controlling the length of the electrical conveyance to maintain a length of the electrical conveyance at a length suitable to maintain the buoyancy of the ultrasonic source at the desired depth.

In another embodiment of the ultrasonic dispersion system or systems outlined above, the ultrasonic particle generator bank comprises multiple ultrasonic sources and a transformer in communication with each ultrasonic source.

In another embodiment of the ultrasonic dispersion system or systems outlined above, the power source is a battery or battery pack incorporated into the ultrasonic generator bank.

In another embodiment of the ultrasonic dispersion system or systems outlined above, the system or systems further comprise an air/particle flow control valve between the outlet and the holding tank operable between an open and a closed position for controlling the rate of flow of the air/particle mixture from the holding tank out the outlet.

In another embodiment of the ultrasonic dispersion system or systems outlined above, the fluid is comprising mainly of water.

In another embodiment of the ultrasonic dispersion system or systems outlined above, the wellbore is a gas wellbore and the fluid that has been dewatered from the gas.

In another embodiment of the ultrasonic dispersion system or systems outlined above, the system further comprises an energy input system sufficient to cause the ultrasonic droplets to change phase from liquid to vapour either before or after entering the secondary treatment system.

In another embodiment of the ultrasonic dispersion system or systems outlined above, the ultrasonic source is a directly coupled ultrasonic atomizer, a horn nebulizer, or a mesh nebulizer.

In yet another embodiment, the present invention provides for a method of disposing of fluid collected from a hydrocarbon well, said method comprising:

depositing fluid collected from a hydrocarbon well into a holding tank;

inputting air into the holding tank;

particlizing the fluid using an ultrasonic particle generator to generate an air/particle mixture; and

dispersing the air particle mixture into the atmosphere or into a secondary treatment system prior to dispersion.

In another embodiment of the method outlined above, the ultrasonic source is a directly coupled ultrasonic atomizer, a horn nebulizer, or a mesh nebulizer.

### BRIEF DESCRIPTION OF THE DRAWINGS

FIG. 1 is an illustrative schematic view of one embodiment of an ultrasonic water dispersion device.

FIG. 2 is a plot showing surface tension energy of 1 L of pure water as a function of the droplet size;

FIG. 3 is a plot showing energy requirements of the commercial mist generators normalized to 1 L of water and superimposed with the scaled surface tension energy curve;

FIG. 4 is a schematic illustration of the interfacial profile as a cavitation bubble near the interface leads to its destabilization and hence pinch-off of an aerosol droplet.⁴;

FIG. 5 shows one embodiment of an ultrasonic atomizer from TDK;

FIG. 6 shows one embodiment of an ultrasonic fountain in water;

FIG. 7 is a schematics of one embodiment of an ultrasonic horn;

FIG. 8 shows an embodiment of an ultrasonic horn atomizer;

FIG. 9 shows an embodiment of a metal mesh nebulizer;

FIG. 10 shows liquid dispersing by an embodiment of a mesh nebulizer;

FIGS. 11A & B shows one embodiment of an experimental setup for testing the mesh nebulizer wherein droplets are generated perpendicularly to the mesh;

FIG. 12 is a chart illustrating evaporation rate from the mesh nebulizer as function of the depth with the mesh oriented at 45 degrees;

FIG. 13 shows one embodiment of a step horn, design #1;

FIG. 14 shows another embodiment of a step horn, design #2;

FIG. 15 shows yet another embodiment of a step horn, design #3;

FIG. 16 is a photograph showing atomization by step horn, design #4;

FIG. 17 is a plot showing a minimum gas (methane) velocity;

FIG. 18 is a plot showing the Reynolds number at minimum velocity;

FIG. 19 is a plot showing the gas flow profile in 4.5″ pipe where V=Vₘᵢₙ, only droplets in the central zone are suspended (A); Vₘᵢₙ=V_{bulk}=Vₘₐₓ/2, half of droplets can be lifted (B); Vₘᵢₙ=Vₘₐₓ/10, 90% of droplets can be lifted (C)

FIG. 20 is a plot showing gas velocity capable of lifting 90% of water droplets

FIG. 21 is a schematic illustration of nebulizer lifted above the water level to disperse water into CBM flow;

FIG. 22 is a schematic illustration of the placing of the mesh nebulizers in a CBM well;

FIG. 23 is a schematic illustration of the lifting of the water to the level of the gas stream may optionally require spreading the water to the pipe wall;

FIG. 24 is a schematic of one type of a horn type nebulizer in the 4.5″ pipe; and

FIG. 25 is a schematic of a set of TDK type nebulizers in 4.5″ pipe.

### DETAILED DESCRIPTION OF THE PREFERRED EMBODIMENT

It will also be appreciated that reference herein to an “ultrafine” particle encompasses those particles that are of a sufficient diameter to be transported by the displacement of the gas within the wellbore of a gas producing well. Such particles include but are not limited to those that behave in accordance to Stokes law. It will be appreciated that the diameter of the particles may vary based on the velocity and/or density of the gas in the wellbore.

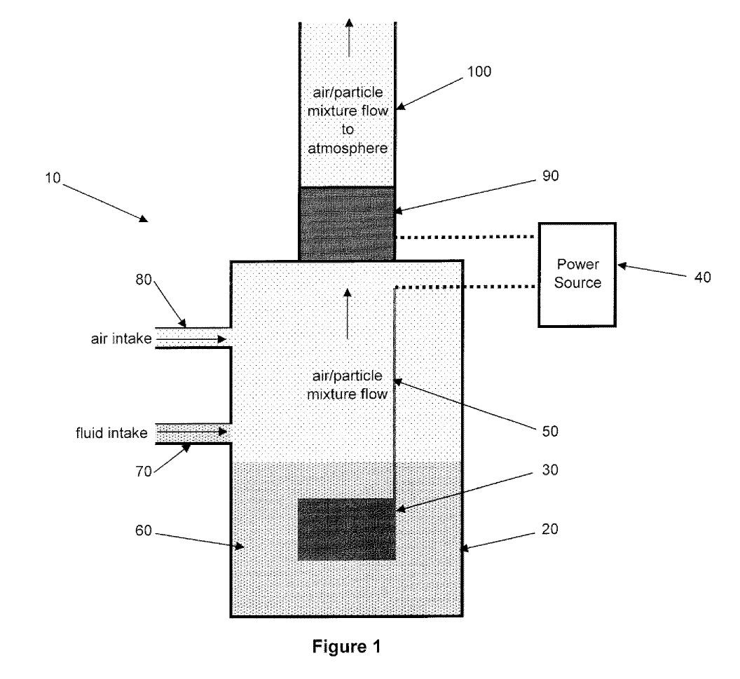

One example of an ultrasonic liquid dispersion system is shown in schematic view in FIG. 1. The ultrasonic liquid dispersion system is shown generally at 10 and is used to disperse produced water that was generated by a hydrocarbon producing well, for example a gas or oil producing well. The generated liquid is removed from the well in a process known as dewatering and collected on the surface for eventual disposal, typically in the form of injection or vaporization. An ultrasonic liquid dispersion system such as that shown at 10 collects the liquid for particlization and airborne dispersion. By particlizing the fluid, it may be evacuated and dispersed into the atmosphere, or into a secondary treatment system for example for removal of particulate or dissolved substances prior to dispersion, for dispersion over a larger area and eventual return to the eco-system.

The ultrasonic liquid dispersion system 10 shown in FIG. 1 includes a holding tank 20 where fluid is collected during the dewatering process from a hydrocarbon well or facility and is input into the holding tank 20 via a fluid intake 70. The fluid collection 60 is held within the holding tank 20 for eventual particlization and dispersion into the atmosphere, or into a secondary treatment system for example for removal of particulate or dissolved substances prior to dispersion.

The ultrasonic liquid dispersion system 10 further includes an air intake 80 for input of air into the holding tank 20. An exhaust outlet 100 is used for output of particlized fluid drawn outwards with air that has been input via the air intake 80. An air/particle flow control valve 90 may be used to control the rate of exhaust from the holding tank and may include a valve for shutting of the exhaust outlet 100 and may also include a fan for drawing the air/particle mixture out of the holding tank 20 for exhaustion. Alternatively or in addition to the fan, the air/particle mixture may be exhausted by air pressure if air is drawn into the holding tank at a rate greater than it is exhausted causing an air flow out of the holding tank 20 and into the atmosphere via the outlet 100. Ideally, a fan is either not required or is positioned such that impact of the fluid particles with the fan or fan blade is reduced to avoid coalescence of the fluid particles which is caused by impact of the particles with each other and is increased when the particles impact the fan and collect on the fan. Other means of exhausting the air/particle mixture may be used without departing from the nature of the invention and the means outlined above are not intended to be limiting but are merely illustrative of certain methods. Exhausting of the water particles may be done if the Vₘᵢₙ of the air exhausting from the holding tank is achieved as will be discussed below.

An ultrasonic particle generator bank 30 placed in the holding tank 20 and in contact with the fluid collection 60 is used to particlize the fluid for dispersion into the atmosphere. The fluid particles are drawn upwards and out of the holding tank 20 via the outlet 10 by the upward flow of the air that has been introduced into the holding tank 20 via the air intake 80. This process may be facilitated by the production of smaller particles which are more easily drawn upwards with the air flow or which require a lower rate of air flow to be drawn upwards for dispersion. The ultrasonic particle generator bank 30 shown in FIG. 1 is powered by a power source 40 which may be positioned on the surface outside of the holding tank 20 or may be incorporated into the unit. Alternatively, the power source 40 may be positioned in the holding tank if appropriate. It will be appreciated that a power source in the holding tank 20, such as a battery, may be used as a power source for the ultrasonic particle generator bank 30.

It will be appreciated that the particles with be drawn in the general direction of the flow of the air which may be in other directions than upwards based on the location of the outlet 10.

In the embodiment shown in FIG. 1, an electrical conveyance 50 transfers power from the power source 40 to the ultrasonic particle generator bank 30. In one embodiment, the electrical conveyance 50 further includes a length management system for extending and withdrawing the conveyance as the level of the fluid collection changes over time.

The ultrasonic particle generator bank 30 may include a transformer as needed as the geometry of bank may vary depending on the volume of fluid to be particlized and/or the shape/dimensions of the holding take. For example, the ultrasonic disks of the ultrasonic particle generator bank 30 may be aligned in a vertical orientation and strung vertically or at a desired orientation. The ultrasonic particle generator bank 30 further includes an ultrasonic source, and generally multiple ultrasonic sources for providing redundancy while increasing longevity and allowing for particle formation rate control. The multiple ultrasonic sources may be powered electrically from the surface, or by other means, for example a battery or battery pack. In addition, in a further embodiment, the ultrasonic particle generator bank 30 includes a buoyancy control for controlling the depth at which the ultrasonic sources may be buoyed below the surface of the fluid collection. An optimal depth may be selected to more effectively particlize the non-gaseous production for exhausting from the holding tank 20. For example, the ultrasonic sources may be submerged about 0-60 mm, or from 0-4 mm or from 1 mm or less below the surface of the fluid collection 60 depending on the type of atomizer, for example, a directly coupled ultrasonic atomizer, a horn nebulizer, or a mesh nebulizer. The buoyancy control is more effective when used together with a length management system for the electrical conveyance 50 so that the electrical conveyance 50 does not add or reduce the buoyancy of the ultrasonic particle generator bank 30 by adding further weight or by pulling upwards on the ultrasonic particle generator bank 30.

Using the ultrasonic sources, ultrafine fluid particles are produced that can be transported like a gas phase in the gas phase (air) out of the holding tank 20. It will be appreciated that the particlized fluid particles have not undergone a phase change and are not gas vapour but are non-gaseous particles and so phase change of the particles from a gas vapour back into a water droplet is not observed as the particlized fluid particles travel upwards with the air flow. Without wishing to be bound by theory, it is predicted that some particles will coalesce on the walls of the holding tank 20 and the outlet 100. However, in order for precipitation to form in the free flowing space, it is predicted that particles will not spontaneously precipitate under static conditions until they are about 500 microns in size, and to coalesce the droplets should be in a net downdraft condition and of varying droplet diameters. Since their targeted creational size is <30 microns the particles can impact and join with a significant number of other particles before they get to a raindrop size and precipitate in the wellbore. Since the particles are in an updraft condition this will reduce their tendency to precipitate. It will be noted that the higher the velocity the greater the momentum (proportional to velocity squared) and the greater the likelihood that a collision will occur and will result in a coalescing of particles. Optimization will require the monitoring of the relationship between air flow velocity and droplet growth.

In addition to using an ultrasonic particle generator in the holding tank 20 to particlize the fluid collection 60 for dispersion of the fluid into the atmosphere, ultrasonic particle formation to disperse chemicals through a pipeline or network of pipelines to provide corrosion protection with the pipeline or network of pipelines. A reservoir of anti-corrosion chemicals may be provided into which an ultrasonic particle generator bank is positioned for particlizing the anti-corrosion chemicals for dispersion within the pipeline or pipeline network. The particlized anti-corrosion chemicals will coalesce on the interior surface of the pipeline or pipeline network thereby providing an application of anti-corrosion chemicals for corrosion protection.

This technology may also be used to reduce explosion hazards in air/methane mixtures. For example, it has been shown that water mist with fine sprays is very efficient in controlling liquid and solid fuel fires and suppressing hydrocarbon mist explosions. Application of ultrasonic generators to a water reservoir may be used during well workovers or in oil storage facilities and/or caverns may be used to reduce the risk of explosion and increase overall safety. A separate application of the use of water mist in non-hydrocarbon wells for controlling fire is disclosed in Z. Liu et al., Journal of Fire Protection Engineering, v. 10, no. 3, 2000, pp. 32-50 and also in Tatem, P. A., et al., “A Review of Water Mist Technology for Fire Suppression,” Naval Research Laboratory, NAL/MR/6180-94-7624, 1994.

It will be appreciated that although the embodiments outlined herein referred to an air intake and the generation of an air/particle mixture for exhaustion from the holding tank into the atmosphere, the air may be substituted with any other suitable gas phase gas or mixture of gases to generate a gas/particle mixture for exhaustion into the atmosphere. All reference to an air intake and air to be mixed with the particles should be understood to include all other suitable gases and gas mixtures which may be mixed with the fluid particles for exhaustion from the holding tank and/or the system into the atmosphere.

In addition to those applications outlined above, an ultrasonic particle generator for the particlization of the non-gaseous production for removal of the non-gaseous production may also be applied to other scenarios such as to blowdown to generate vapour (as compared to flashing by pressure drop). Ultrasonic particlization may also be applied as a means for water treatment (similar to evaporation technology) wherein it may be used to create an ultrafine mist from the produced water which would then require less energy to vaporize the mist as the produced water itself.

Further, an ultrasonic particle generator may be used in combination with steam generators, which may be distant, for example several kilometers, from the wellhead. An ultrasonic particle generating may be positioned at or near the well head to convert condensed water (generally at very high pressure), which forms when the steam travels long distances in pipes and cools. The ultrasonic device could convert the condensed water to ultrafine particles. The energy within the steam flowing in the pipe may be sufficient to re-vaporize the ultrafine particles at the well head back to steam, thus increasing the steam quality being injected into the wellbore. Ultrasonic devices may be placed along the pipe at locations where condensation is typically observed.

Furthermore, ultrasonic particlization of the non-gaseous production may be used at tailings ponds, in an oil-water separation application wherein ultrasonic devices may be used on or near the surface to cause coalescence of emulsions and enhance separation. The ultrasonic particle generator may be operated to generate particles of water leaving the oil in a liquid state, or vice-versa.

In addition, an ultrasonic particle generator may be used to generate a mist within a steam separator to increase the surface-area of droplets, and thus induce more evaporation of vapour from the blowdown liquid.

Further, an ultrasonic particle generator may be employed by a lower pressure mist generator vessel after the steam separator to recover a low-pressure water vapour stream from the hot boiler blow-down. Such an application may be used to bring the blowdown flashing step closer to thermodynamic equilibrium by increasing the liquid surface area.

In addition, an ultrasonic particle generator may be used when introducing diluent into process emulsion (before a free-water knockout and/or treater) to finely disperse condensate as a “pseudo-mist in a liquid”. This may reduce localized areas of high condensate concentration that could lead to asphaltene precipitation from the bitumen.

It will be appreciated that various modifications, revisions and/or additions may be made to the systems and methods outlined herein without departing from scope of the invention and these modifications, revisions and/or additions are within the contemplated scope of the invention. In addition, it will be appreciated that the embodiments outlined above are merely illustrative of various contemplated embodiments and are not intended to be limiting in any way.

### Experimental Work

It will be appreciated that the following experimental section is directed to embodiments of various aspects of the invention, including aspects of the application of the concept of dewatering through the use of ultrasonic devices when applied to a wellbore, which are not intended to be limiting but merely illustrative of the concept of atomization of a liquid such as water using various ultrasonic devices and implementation methods. The invention is not limited by these devices and methods or the implementation techniques outlined in this section. It will be appreciated that mention and disclosure of tests or theories applied to ultrasonic dewatering of a wellbore may be applied to the ultrasonic dewatering of a holding tank or the like.

All indication of volume, performance, orientation, dimensions, power output and materials is simply intended as illustrative and should not be deemed as essential or as a promise or guarantee or utility or performance.

### Mist Generation

### Starting Point: Calculated Energy for Water Dispersion

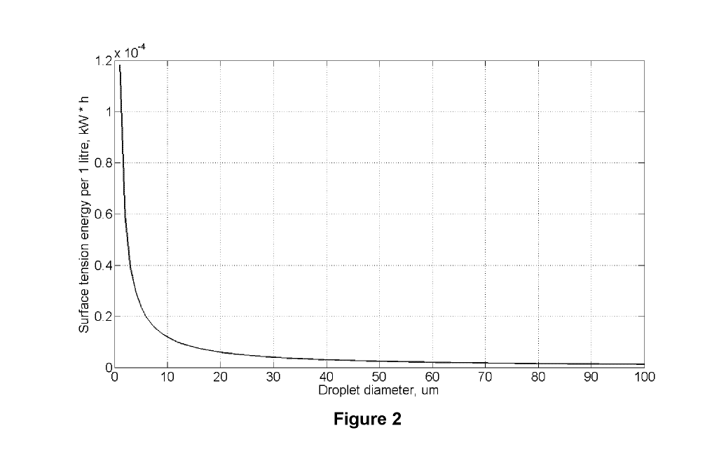

The energy required for mechanical generation of the mist from water can be calculated based on surface tension. The surface tension of the bulk water which is contained in a volume unit (1 L) is fairly low due to small surface area. The surface area is increased while this volume is dispersed into miniature droplets. The volume of the ordinary droplet is proportional to R³, subsequently the number of droplets is changed as 1/R³, where R is the radius of the droplet. As the surface of the ordinary droplet is proportional to R², the total surface area of the mist is changed with R as 1/R. Thus the finer the mist, the more energy is required to produce it. FIG. 2 represents the absolute surface tension energy of the 1 L of water as a function of the droplet size. For practicality, the data is presented in kW*h as oppose to scientific values in Joules.

### Real Power Consumed, Real Efficiency

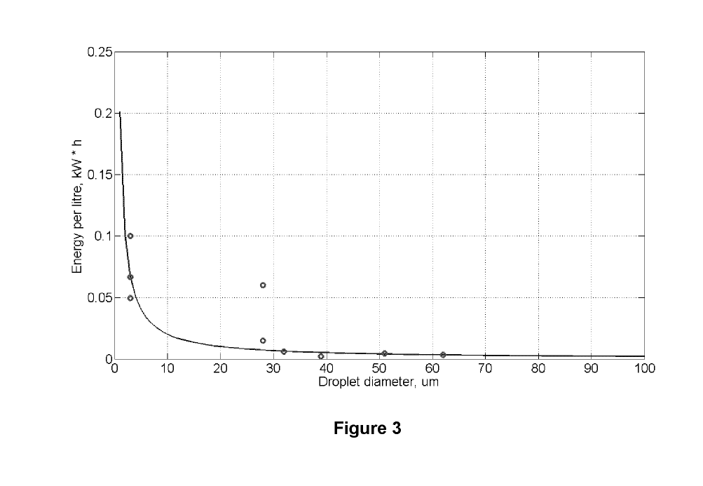

The calculated data in FIG. 3 is fairly optimistic; only 0.04 W*h is needed for dispersing of 1 L of water into a 3 μm mist. This represents only 0.8 W of power for permanent evaporation of required 20 L per hour which is the power of one LED lamp. The practical data is very different though.

The Table 1 presents data for several commercial ultrasonic mist generators.

| | | | Mist | |
|---|---|---|---|---|
| | Power, | Mean droplet | rate, | |
| Manufacturer | W | diameter, μm | L/h | Note |
| TDK | 30 | 3 | 0.45 | 1.6 MHz |
| TDK | 13 | 2 | 0.20 | 2.4 MHz |
| STULZ-Ultrasonic | 495 | 3 | 10 | |
| New Tech Trading | 1800 | 3 | 18 | |
| Hangzhou Success | 500 | 62 | 150 | YPW63, 15 kHz |
| Ultrasonic | 300 | 51 | 70 | YPW61, 20 kHz |
| Equipment Co. | 100 | 39 | 50 | YPW59, 30 kHz |
| | 60 | 32 | 10 | YPW57, 40 kHz |
| | 30 | 28 | 0.5 | YPW51, 50 kHz |
| | 30 | 28 | 2 | YPW55, 50 kHz |

FIG. 3 superimposes power of the listed above devices normalized to one liter of water and scaled to the surface tension energy curve. The scale factor is 1700 giving us efficiency of about 0.06%.

### Efficiency

The estimated efficiency of less than 0.1% is in accordance with data presented in the recent monograph.²

The heat vaporization of pure water is 2260 kJ/kg which is equivalent to 627 W*h or 0.6 kW*h. That is still much higher than any real mechanical atomizer consumes. Another words, ultrasonic atomizers are much more efficient than thermal vaporization.

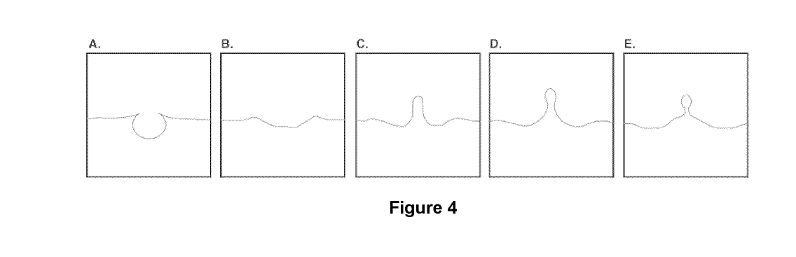

The mechanism of ultrasonic atomization has not been fully understood yet. This phenomenon is fairly complex from an engineering point of view as it is influenced by properties of liquid, its amount and temperature, geometry of the transducers, operating frequency, applied voltage, etc. The complexity is coming from a not-fully known physics of the atomization process. According to the classic hypothesis, the generation of the aerosol droplets involves cavitation which occurs when vapor bubbles are formed in the liquid as the pressure in a localized region of the fluid suddenly decreases owing to the periodic disturbances introduced by the sound excitation.² If the local pressure falls below the vapor pressure during the negative half cycle of the oscillation, the liquid in that region essentially “boils” to form a vapor pocket. On the positive half cycle of the oscillation, these bubbles suddenly collapse with such intensities that extremely high instantaneous pressures and accelerations are generated in the form of shock waves. According to a second theory, the disturbance shock waves resulting from the implosion of the bubbles during cavitation lead to the excitation of finite amplitude capillary waves that result in droplet ejection.³ This theory dominates in explanation of the aerosol formation by ultrasonic transducers placed in the liquid and is illustrated in FIG. 4.

Whichever mechanism is responsible for the excitation of capillary wave on the interface, a critical threshold amplitude of the waves must be exceeded before the onset of nebulization resulting from their destabilization. The critical amplitude α_{c} is given by:

$${a}_{c} = \frac{2 μ}{ρ} {( \frac{ρ}{π γ ω} )}^{\frac{1}{3}}$$

Where β, ρ, γ—is the viscosity, density and surface tension of the liquid and ω=2πf. For water at 10° C. to 20° C. and frequency f of 10 kHz, 100 kHz, and 1 MHz, the critical amplitude α_{c} will be equal to 0.13, 0.06 and 0.03 μm, respectively.

### Ultrasonic Versus Hydraulic Atomization

A hybrid solution which represents ultrasonic atomizer together with the air supply (or, in general, gas carrier) is effectively used in ultrasonic sprayers providing satisfactory droplets size and large volume rate.

Another option is hydraulic dispersion in which the liquid is passed under considerable pressure through a nozzle. The pressure in hydraulic atomizers is about 80 to 100 bar. The advantage of the hydraulic dispersion is its high efficiency. In fact, this is the most efficient method of water atomization as it allows dispersing of 1 m³ of water by using only 2 kW of power.5

The practical merit of such an economical approach, however, requires further investigation due to the need of having a miniature high-pressure down hole hydraulic pump. Also, the droplet size may vary and as result Prof. R. Christiansen observed about 70% of hydraulically formed water droplets were stuck to the pipe wall¹

Shalunov A. V. claimed achieving the efficiency above 0.5% by directing the water stream horizontally on a vertically placed large (42 cm) piezo disk.⁵ However, this approach is not applicable for ultrasonic wellbore dewatering devices (UWDD) or ultrasonic produced water dewatering.

### Methods for Ultrasonic Mist Generation

Ultrasonic atomizers can be divided in three groups:

Transducers immersed in the liquid, direct energy transfer;

Transducers displaced from the liquid, the energy is transferred trough special attachments (horns); and

New type of nebulizers with mesh actuators.

### Transducer Immersed in the Liquid

An ultrasonic atomizer developed by TDK was used. Direct coupling was used between the piezo element and the vaporizing liquid (water).

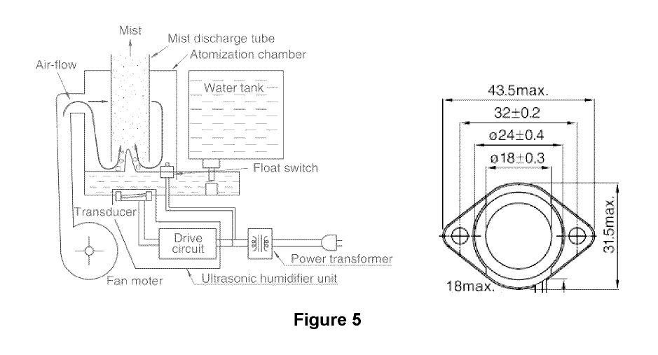

The method requires an active control of water level above the ultrasonic transducer to avoid overheating the piezo element. The optimum level is from 40 to 45 mm. A very similar product is offered by the APC with optimum water level of about 30 mm. The atomization rate is from 300 to 500 mL/h, as illustrated in FIG. 5.

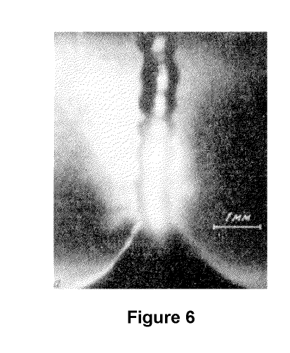

This type of ultrasonic nebulizers has been popular in medical application for several decades. The ultrasonic fountain in the water (FIG. 6) can be cost-efficiently achieved, and it is widely used for decoration.

The method, however, has not found any valuable application in the industry. The reason is its limited power. The transducer cannot be simply scaled up to get higher atomization rate as water starts sporadically dispersing thus reducing the water level from its optimum. The atomizer becomes a demonstrator of a volcano eruption.

Placing number piezo elements of 20 mm to 25 mm in diameter allows a parallel work of several transducers simultaneously. That is one potential approach for UWDD or alternatively for ultrasonic produced water dewatering. For the UWDD the number of elements is limited though by the pipe diameter, about 22 of elements will fit into the 4.5″ pipe.

Transducers Displaced from the Liquid, Half Wave Couplers

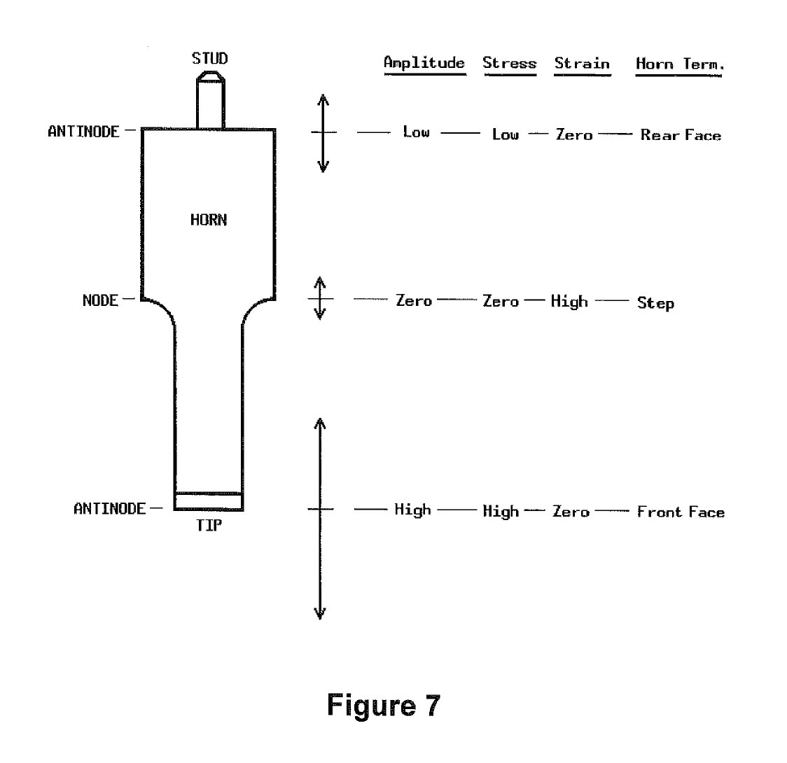

High volume atomizers can be built based on coupling the piezo element to the liquid via a probe (a horn) which length is equal to half of a wavelength. The probe is made from low-density metals such aluminum or titanium. These types of atomizers operate at a frequency range from 20 to 100 kHz, consequently the probe length is from 2.5 to 12.5 cm. Horns are designed to achieved the maximum vibration amplitude at the tip (FIG. 7).

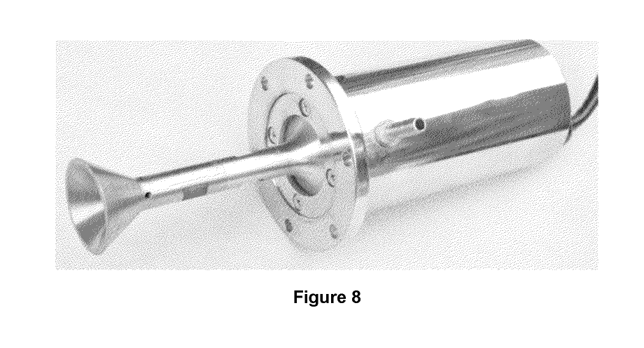

Most of technological ultrasonic equipment such as welders, sprayers, mixers, etc. is built this way. The horn is bolted to a powerful Langevin ultrasonic transducer. For atomizing, the liquid is delivered through the transducer or through the base of the horn as shown in FIG. 8.

Some horn atomizers have the liquid feed channel passing near the node instead of going along the axis of the device.

Horns transfer the power of transducers into a smaller area at the horn tip. As oppose to direct coupling, all processes occur in the proximity of the horn surface. The active depth depends on amplitude of the vibration and is typically less than 1.0 mm.

### Thin Plate Couplers, Mesh Nebulizers

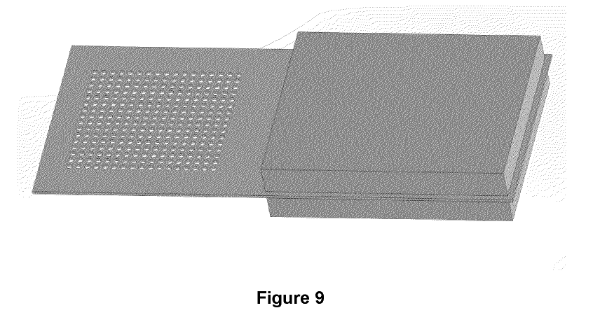

Piezo elements operate more efficiently in a radial mode rather than in axial mode. Conversion of the radial vibration into axial displacement is therefore necessary. The most compact solution can be achieved using a metal mesh nebulizer. The active element in this device represents a thin (0.1-0.2 mm) metal foil with a number of miniature holes (10 to 200 μm diameter). The foil is placed between two piezo elements as shown in FIG. 9.

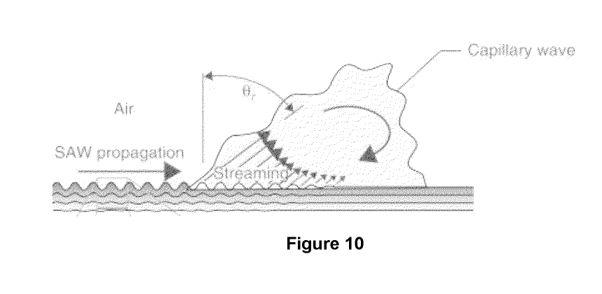

Radial vibration of thin piezo elements translates into the longitudinal displacement of the foil. Small amount of water placed on the top of the foil is dispersed effectively by the vibration; the mesh structure of the foil enhances the effect due to the surface acoustic waves (SAW), as shown in FIG. 10. Such design is used in miniature, low-power consumer sprayers.⁶

The size of actuators may be about 12×12 mm, the mesh nebulizers cannot be scaled up as they disperse water only at the edge of the mesh. Full covering of the mesh even with a thin water layer will result in immediate interruption of the atomization due to disappearance of the SAW.

### Testing

### Metal Mesh Nebulizer

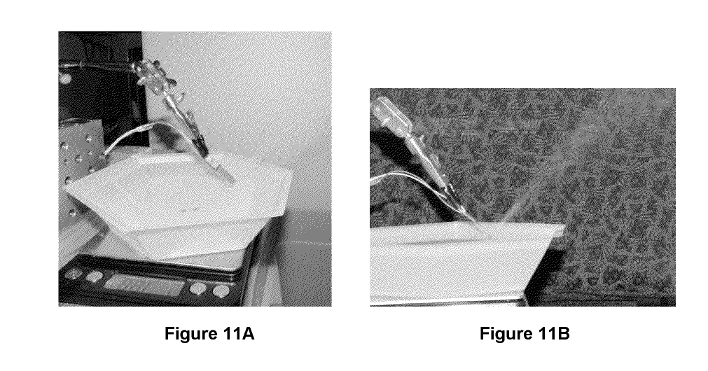

A metal mesh nebulizer with a 12×12 mm mesh was fixed in a 3D optical translation stage as shown in FIG. 11. The nebulizer was powered from a custom generator with tunable frequency from 100 to 150 kHz. The peak-to-peak voltage was constant and equal to 12V. A water container was placed on a digital scale with resolution of 0.01 g. The nebulizer was oriented at 45 degree angle to the water surface.

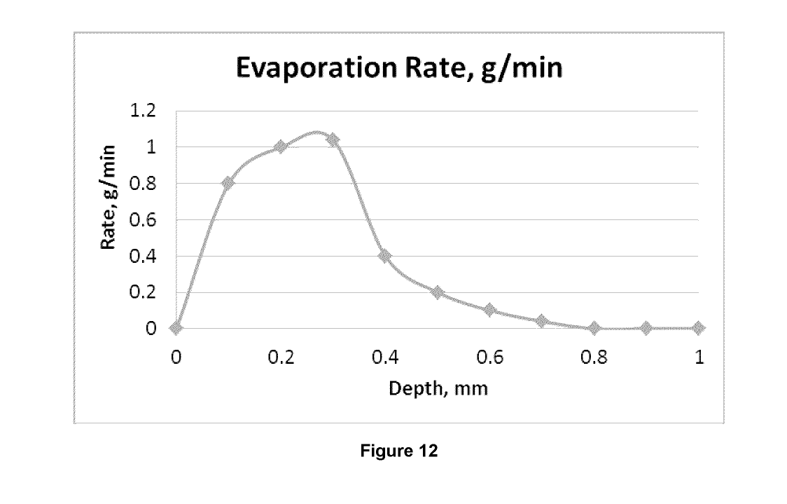

FIG. 12 shows the experimental data on evaporation rate as a function of the depth. The maximum rate was recorded at the depth of 0.3 mm which was equal to 1.05 g/min. Deeper placement of the mesh into the water drastically reduced the atomization. The evaporation was entirely stopped at the depth of less than 1.0 mm. The maximum consumed power was 0.75 W and it remained practically unchanged with the depth. Generated droplets were oriented perpendicularly to the mesh.

Changing the orientation of the mesh from 45 degrees reduced the evaporation rate. The maximum rate dropped to 0.5 g/min at 30 degree and below 0.2 g/min at 60 degree. Placing the mesh horizontally stopped the evaporation entirely.

The data above is equivalent to the maximum Watt*Hour production of 84 g. Evaporation of 1 L and 20 L of water will need 12.0 and 240 W*h, respectively. Therefore, the mesh nebulizer appears to be about 5 times more efficient than the direct coupled nebulizer from TDK.

### Horn Atomizers

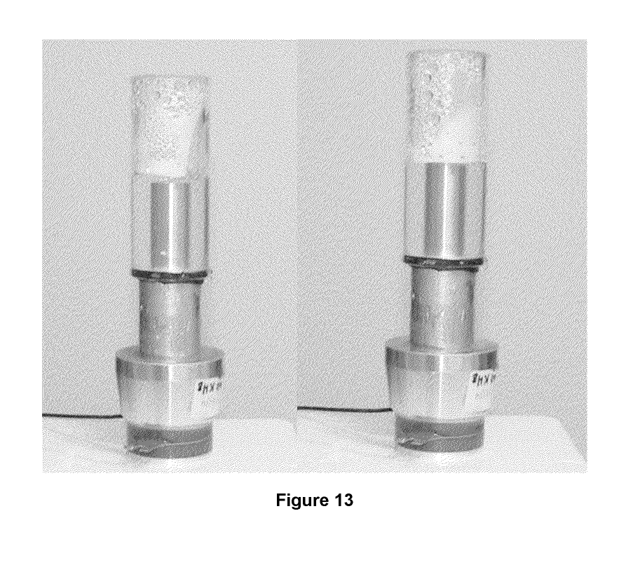

The first model of the step-type horn was prototyped from 6061 aluminum, the diameter of the bottom and upper parts was 25.4 and 12.7 mm, respectively. The horn was firmly bolted to a 40-kHz 60 W Langevin transducer. The transducer was powered with 300 Vp-p. An acrylic pipe was mounted in the location of the node (FIG. 13). The pipe was filled with water to simulate water collection from the pipe wall.

The vaporization started after reducing the water layer to approximately 1.0 mm above the tip. The atomization was accompanied with sporadic eruptions which were spreading large water aggregates. The appearance of the tip was changed from shiny & polished to dull due to degradation of the surface under cavitation.

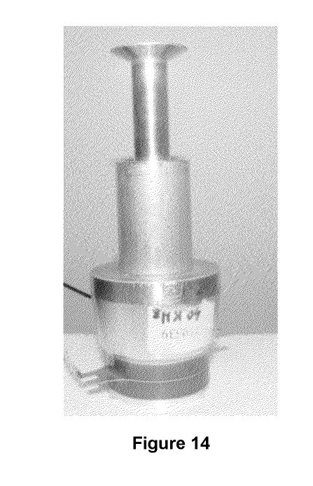

A second horn was machined with an extension at the tip, FIG. 14. The extension had the same diameter as the bottom part of the horn, 25.4 mm.

The second horn had a secondary resonance peak at approximately 45 t kHz which was the result of superposition of the original 40 kHz transducer peak and overtones of the conical extension of the horn.

The water was delivered on the tip from the top. The second horn dispersed the water more intensively; however, the intensity depended on location of the water and its amount. Larger droplets of water were collected closer to the center without getting dispersed for a long time.

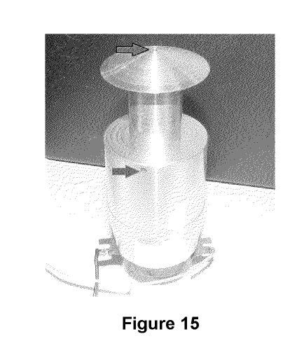

The third step horn has a delivery channel through the center as shown in FIG. 15. The radial part of the channel was drilled close to the step where minimal displacements are taking place. The outer dimension of the horn matched the transducer diameter of 44.40 mm (1.75″) and the thinner part was 22.20 mm. The horn ended up with a 150-degree cone.

Preliminary testing shows that the main transducer resonance of 40 kHz split by several overtones. The water dispersing depended on the amount of water and orientation of the setup. A slight deviation of the horn from the vertical orientation changed the amount of water on the corresponding side of the cone and that was accompanied with the sporadic atomization. The test indicated, therefore, that taking more power from the transducer does not necessarily mean a better performance of the nebulizer if the power is spread over the large dispersing tip.

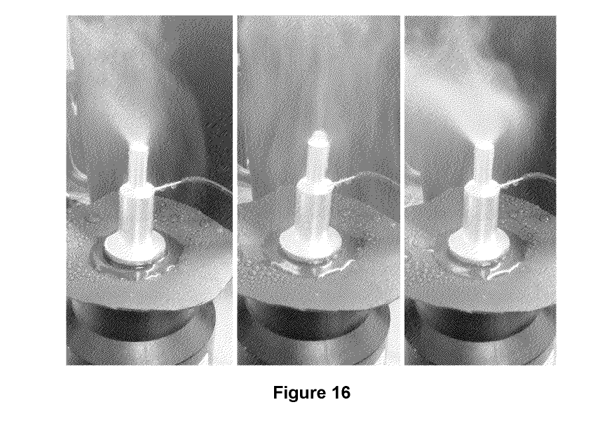

The prototyping of the forth horn included the modification of the basic 28-kHz Langevin transducer. Its base was machined out to OD of 25 mm at the length of 26 mm. The step horn had same diameter at the bottom (20 mm long) and 12.5 mm diameter upper part. The delivery channel of 2.0 mm diameter was drilled along the axis, its radial part was machined close to the location of the step, FIG. 16.

Atomization from the forth step horn was the most consistent from all horn type nebulizers above. The resonance frequency increased to 33 kHz, such a high shift was not anticipated based on modeling in Solid Works although it may be influenced by reducing the counter-mass of the transducer and location of the delivery channel. The measured actual power was 24 W and the dispersion rate was near 10 mL/min or 600 mL/hour. This efficiency was better than one can get from the TDK type of nebulizers although it was still lower than we achieved from the mesh nebulizers.

The horn type nebulizers are particularly sensitive to horn geometry, type of transducers and their coupling to the horn, material, etc. They can reach efficiency of 0.1% by generating water droplets of 30 μm.5 The evaporation rate of 20 L/hour will require only 40 W of power which is less than 1/30 of the standard TDK nebulizers. Scaling up the power is not exactly linear, one should expect the real output of the horn type nebulizers as 150 W for 20 L/hour.

### Gas Lift

### Droplet Size and Minimum Gas Flow

Condensed water can be lifted by methane up to the wellhead according to the UWDD concept. This paragraph is devoted to the estimation of the minimum gas velocity needed for lifting the water droplets. Such velocity can be directly calculated as a terminal velocity from Stokes law:

$${V}_{min} = \frac{2}{9} \frac{{ρ}_{w} - {ρ}_{g}}{μ} g {r}^{2}$$

Where: ρ_{w} is the density of the water; ρ_{g} is the density of the gas; μ is the dynamic viscosity of the gas; g is the gravitational acceleration; r is the radius of the droplet.

Properties of pure methane under normal conditions (temperature 20° C. and atmospheric pressure) are: ρ_{g}=0.664 kg/m³; μ=1.1*10⁻⁵ Pa s.

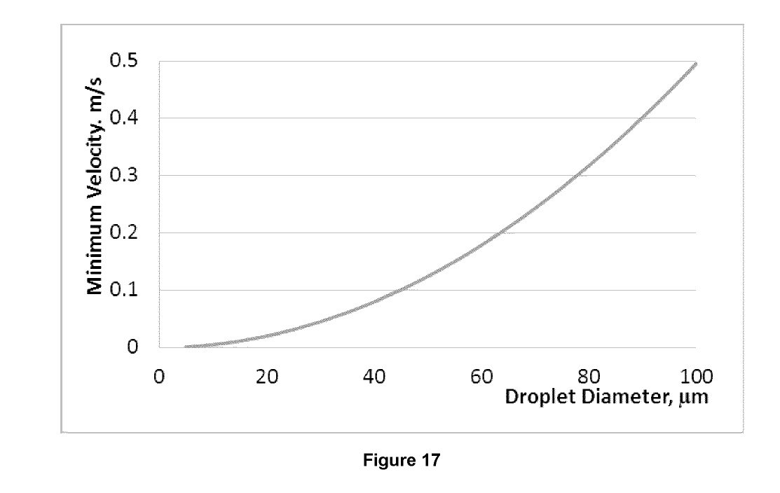

Calculated minimum gas velocity is presented in FIG. 17 as a function of the droplet size.

Droplets will be suspended in the gas which moves with minimum velocity Vₘᵢₙ. The flow regime is expected to be laminar due to low value of Vₘᵢₙ and a small pipe diameter. Reynolds number for a bulk velocity of Vₘᵢₙ/2 and low amount of water droplets in the flow is equal to:

$$Re = \frac{{V}_{min}}{2 μ} D {ρ}_{g}$$

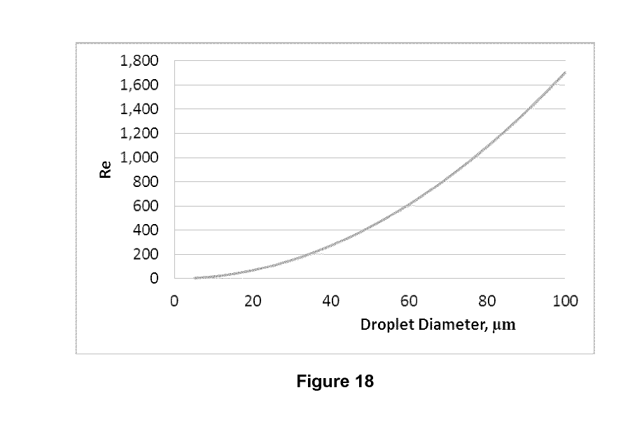

and is plotted in FIG. 18.

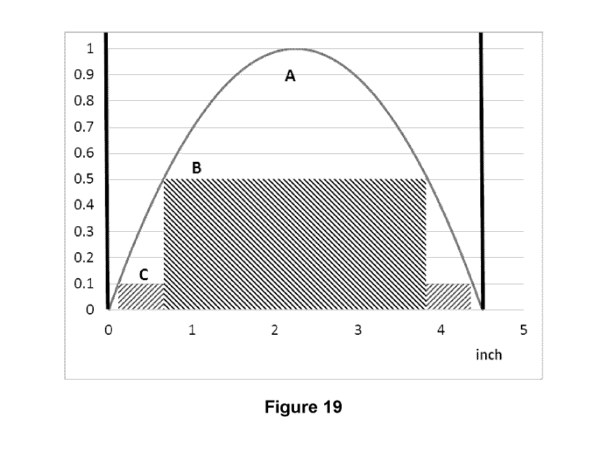

As it seen from FIG. 18, flow regime will be laminar over the entire range of droplet size. This means that a correction factor ×2 should be applied for Vₘᵢₙ to account for the bulk velocity. Otherwise, only a central part of the gas flow will be able to suspend droplets (FIG. 19).

Assuming the uniform distribution of droplets in the pipe, the gas flow of V=2Vmin (correction factor ×2) should lift half of droplets in the pipe. Correspondently, selecting the correction factor ×10 should assure lifting of 90% of all droplets.

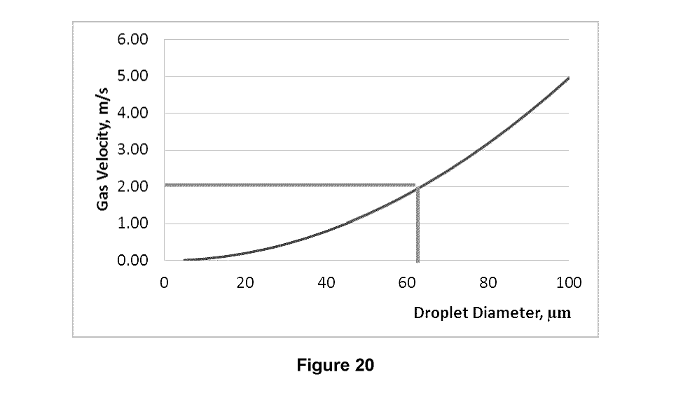

FIG. 20 presents calculated data of Vmin multiplied by the correction factor ×10. The underlined value of 2.0 m/s corresponds to droplet size of approximately 60 μm.

The required dewaterization rate of 20 L/h increases the density of the mixture by approximately 0.27 kg/m³ at velocity of 2.0 m/s. This corresponds to a higher Reynolds number of about 18,000 which indicates that flow regime become turbulent. Turbulence increases the friction between gas and water droplet by a factor Cₜ:⁷

Cₜ=1+0.16Re^{3/2}

Correspondently, one should expect a better gas lifting due to turbulence when the water content increases.

### Location of the Nebulizer

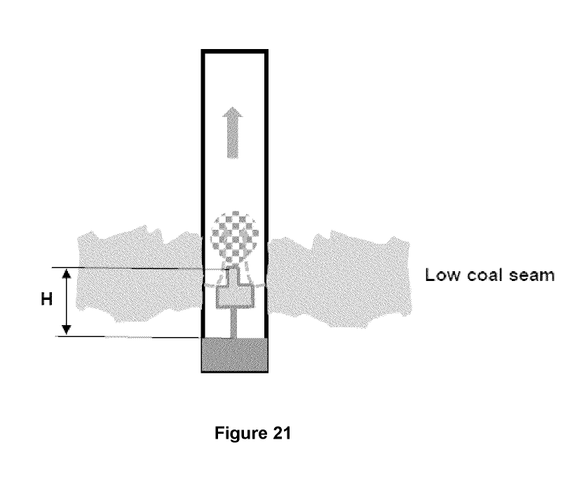

Gas flow in the CBM well (an example of a low flow, low pressure gas well) begins from the lowest level of the coal seam which is located above the bottom of the well. As the dispersed water droplets have almost the same temperature as the surrounding gas, they do not spread too far from the nebulizer without being picked up by the gas flow. Therefore, the nebulizer should be lifted up to the level where gas flows at least with minimum velocity Vₘᵢₙ, FIG. 21.

Lifting the nebulizer to the height H from the water surface (or a bottom of the well) may be done using for example a small water pump producing at least 20 L/h at pressure of a few bars.

### Practical Considerations, Recommendations and Conclusions

### Mesh Nebulizers

Mesh nebulizers represent an elegant and efficient ultrasonic atomizing solution. They operate at frequencies above 100 kHz, which allow generation of quite small and easy to lift water droplets.

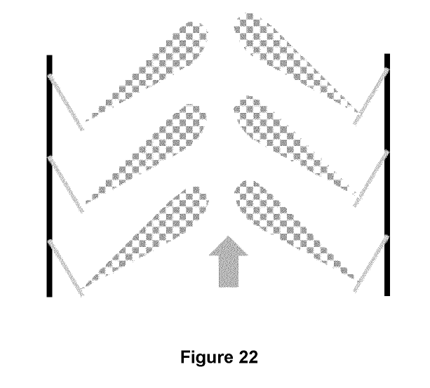

Several rows of nebulizers may be required to achieve a desired particlization rate by placing the nebulizers along the pipe wall (FIG. 22).

Mesh nebulizers generate water mist generally perpendicular to the mesh, and a 45 degree orientation of the mesh was found to be optimal in terms of generating efficiency. Therefore, the mist will be directed under 45 degree to the pipe instead of being dispersed vertically up. One should expect some mist deposition on the pipe wall before some droplets will be drafted up by the gas flow.

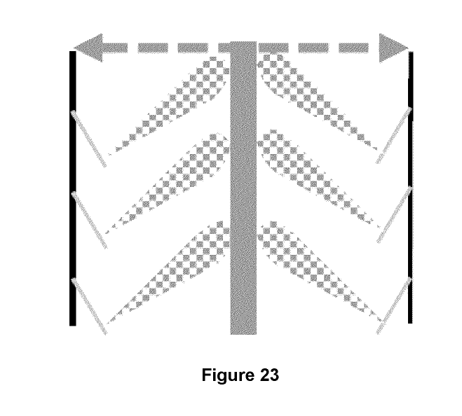

3) Water lifted from the bottom at the height H may be dispersed to the pipe wall in order be picked up and dispersed by the mesh actuators (FIG. 23)

### Horn Nebulizers

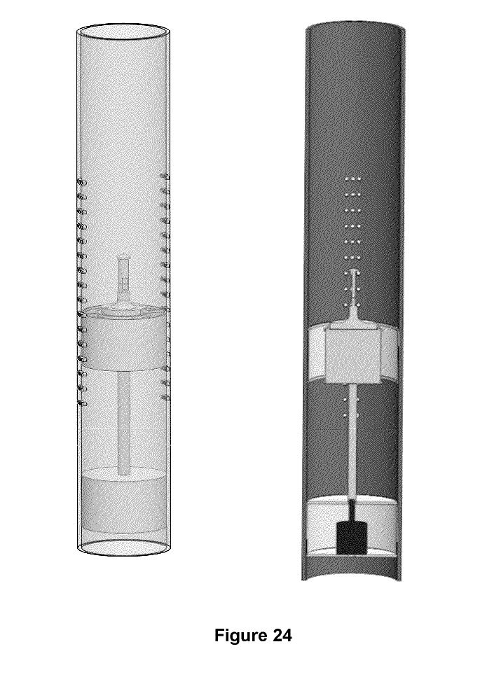

Horn nebulizers are a robust and versatile atomizing tool. They can disperse high power within a limited volume and they do not suffer from overheating when the water level is low. Horn type nebulizers generally pair with a pump, such as a micropump, as they do not disperse bulk water. However, the pump is needed in the UDWW anyway for lifting the water level at the height H. In one embodiment, the nebulizer may be positioned in the center of the pipe for the UDWW. It will occupy the space of approximately 70 mm in diameter which is approximately 40% of the pipe cross section (FIG. 24.)

### High-Frequency Direct Coupling

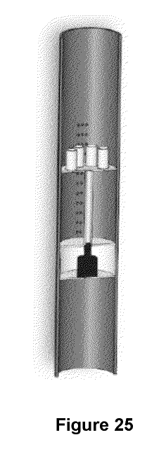

High-frequency (for example 1.6 or 2.4 MHz) ultrasonic atomizers based on direct coupling of piezo elements to the water provides the tiniest water droplets which can be lifted by very low gas flow as shown in FIG. 25. Their maximum power is generally limited. Given a production rate of a single unit of approximately 0.5 L/hour, a total of 40 devices would be needed for a volume of 3 bbd.

### REFERENCES

1. Christiansen R. L. New Technologies for Lifting Liquids from Natural Gas Wells, report for DOE, Colorado School of Mines, 2003
2. Plesset M. S., Prosperetti A. “Bubble Dynamics and Cavitation”. Annu. Rev. Fluid Mech. 1977, 9; 145-185
3. Boguslayskii Y. Y., Ekhadyosants O. K. “Physical Mechanism of the Acoustical Atomization of a Liquid” Sov. Phys. Acoust. 1969, 15, 14-21.
4. Boulton-Stone J. M., Blake J. R. “Gas Bubble Bursting at a Free Surface” J. Fluid Mech. 1993, 254: 457-66.
5. Khmelev V. N., Shalunov A. V., Shalunova A. V. “Ultrasonic Dispersion of Liquids”—Altai Tech Univ., 2010, (in Russian).
6. Yeo L. Y., Friend J. R., etc. “Ultrasonic Nebulization Platforms for Pulmonary Drug Delivery”. Expert Opin. Drug Deliv., 2010, 7: 663-679.
7. Van Boxel J. H. “Numerical Model for the Fall Speed of Raindrops in a rainfall simulator”—Workshop on Wind and Water Erosion, 1997, p. 77-85

What is claimed is:

1. An ultrasonic dispersion system for dispersing fluid collected from a wellbore during hydrocarbon production, the ultrasonic dispersion system comprising:
a holding tank for containing a fluid collection;
a fluid intake in communication with the holding tank for input of fluid collected from a wellbore;
an air intake in communication with the holding tank for input of air;
an ultrasonic generator bank in the holding tank for contact with the fluid collection for particlizing the fluid collection to generate an air/particle mixture with the air input into the holding tank; the ultrasonic generator bank comprising:
an ultrasonic source for positioning below the surface of the fluid collection for particlizing at least a portion of the fluid collection;
a power source for providing power to the ultrasonic generator bank; and
an outlet in an upper region of the holding tank for exhausting the air/particle mixture from the holding tank into the atmosphere or into a secondary treatment system prior to dispersion.

2. The ultrasonic dispersion system of claim 1, wherein the ultrasonic particle generator bank further comprises a buoyancy control for positioning the ultrasonic source a desired depth below the surface of the fluid collection.

3. The ultrasonic dewatering system according to claim 2, wherein the desired depth is between about 0 mm and 4 mm.

4. The ultrasonic dewatering system according to claim 3, wherein the desired depth is about 1.0 mm or less.

5. The ultrasonic dispersion system according to claim 1, further comprising:
an electrical conveyance electrically connecting the power source and the ultrasonic particle generator bank.

6. The ultrasonic dispersion system of claim 5, wherein the electrical conveyance further comprises a length management system for controlling the length of the electrical conveyance to maintain a length of the electrical conveyance at a length suitable to maintain the buoyancy of the ultrasonic source at the desired depth.

7. The ultrasonic dispersion system according to claim 1, wherein the ultrasonic particle generator bank comprises multiple ultrasonic sources and a transformer in communication with each ultrasonic source.

8. The ultrasonic dispersion system according to claim 1, wherein the power source is a battery or battery pack incorporated into the ultrasonic generator bank.

9. The ultrasonic dispersion system according to claim 1, further comprising an air/particle flow control valve between the outlet and the holding tank operable between an open and a closed position for controlling the rate of flow of the air/particle mixture from the holding tank out the outlet.

10. The ultrasonic dispersion system according to claim 1, wherein the fluid is comprising mainly of water.

11. The ultrasonic dispersion system according to claim 1, wherein the wellbore is a gas wellbore and the fluid that has been dewatered from the gas.

12. The ultrasonic dispersion system according to claim 1, wherein the system further comprises an energy input system sufficient to cause the ultrasonic droplets to change phase from liquid to vapour either before or after entering the secondary treatment system.

13. The ultrasonic dewatering system according to claim 1, wherein the ultrasonic source is a directly coupled ultrasonic atomizer, a horn nebulizer, or a mesh nebulizer.

14. A method of disposing of fluid collected from a hydrocarbon well, said method comprising:
depositing fluid collected from a hydrocarbon well into a holding tank;
inputting air into the holding tank;
particlizing the fluid using an ultrasonic particle generator to generate an air/particle mixture; and
dispersing the air particle mixture into the atmosphere or into a secondary treatment system prior to dispersion.

15. The method of claim 14, wherein the ultrasonic source is a directly coupled ultrasonic atomizer, a horn nebulizer, or a mesh nebulizer.
